(19) United States
(12) Patent Application Publication
(10) Pub. No.: US 2026/0117901 A1
(43) Pub. Date: Apr. 30, 2026

(54) Fitting and System for Connecting Pipes with a Functional Unit

(71) Applicant: Viega Technology GmbH & Co. KG, Attendorn (DE)

(72) Inventors: Andreas Müller, Freudenberg (DE); Bernd Franke, Finnentrop-Schönholthausen (DE); Ulrich Arning, Attendorn (DE)

(21) Appl. No.: 19/163,578

(22) PCT Filed: Mar. 7, 2024
(86) PCT No.: PCT/EP2024/055972

§ 371 Date: Sep. 9, 2025

(30) Foreign Application Priority Data
Mar. 10, 2023 (DE) 10 2023 106 014.7

(51) Int. Cl. F16L 19/12

(52) U.S. Cl. CPC F16L 19/12

(57) ABSTRACT

A fitting for connecting to a pipe, including a base body having at least one pipe section, a pressing section connected to the pipe section, and a functional unit connected to the pressing section. The functional unit includes a functional ring, a sealing element and a fixing element, wherein the functional ring, has an outer section arranged radially outside the pressing section and an inner section arranged inside the pressing section, and wherein the inner section positions the sealing element and the fixing element inside the pressing section. The fitting solves the technical problem of enabling easier and more reliable replacement of the functional parts. The invention also relates to a functional unit and a system.

### CROSS-REFERENCE TO RELATED APPLICATIONS

This application is the United States national phase of International Patent Application No. PCT/EP2024/055972 filed Mar. 7, 2024, and claims priority to German Patent Application No. 10 2023 106 014.7 filed Mar. 10, 2023, the disclosures of which are hereby incorporated by reference in their entireties.

### BACKGROUND OF THE INVENTION

### Field of the Invention

The invention relates to a fitting for connecting pipes, a functional unit for a fitting and a system for connecting pipes.

### Description of Related Art

The technical field relevant to the present invention is the installation of piping systems on construction sites, in which generally a piping system consisting of pipe sections and fittings is installed for conducting and guiding a fluid, i.e. a liquid or a gas. A fitting, also known as a press connector, is basically understood to be a connecting piece for a pipe, and a fitting is most commonly used to connect two or more pipe sections. Accordingly, the fitting preferably has two or more pressing sections, for example in the form of pressing sleeves. The most common fittings include straight connections, directional changes in the form of pipe bends, reducers, branches such as T-pieces or crossings. However, a fitting can also refer to a pipe connection for a tab or other component. For example, thermometers or pressure gauges as tabs only have one connection for a pipe section. This means that the fitting of a tab only has one pressing section for connecting a pipe section to the tab.

Press connections are used to connect the pipe sections to the fittings and other components, in which press connections a pressing section of a fitting, when the pipe section is inserted, is radially formed inwards using a pressing jaw in such a way that a permanent and tight, and in some cases even permanent, connection is created. The fittings may be provided with a sealing means, for example an O-ring, which ensures the tightness of the connection, or they can be designed to seal by means of direct contact between the materials of the pipe section and the fitting, for example metallically.

The pressing technology used for radial forming of the pressing section mainly involves radially acting pressing systems as well as pressing systems that use radial-axial pressing, whereby part of the fitting is displaced axially during the pressing process in order to effect radial forming.

The piping systems described above are used in particular for transporting potable water or heating water, gas for operating a heating system or industrial gases. In principle, any fluid medium can be transported in the pipes.

On the one hand, rigid materials, in particular metallic materials, are used as materials for rigid pipes. rigid plastics are also suitable as materials. Such pipes are preferably used in installations with larger straight sections along walls or ceilings or within wall or ceiling structures. Pipes made of these materials are dimensionally stable and can be connected with fittings by means of a seal that acts only from the outside. Materials used for rigid pipes include in particular metals such as stainless steels such as ferritic steels like 1.4521, austenitic steels like 1.4404, duplex steels like 1.4462, red brass, SiBr, copper, but also rigid plastics such as cross-linked polyethylene (PE-X), polyethylene with increased temperature resistance (PE-RT), polyvinyl chloride (PVC) and polypropylene (PP) with appropriate wall thicknesses. Furthermore, multi-layer composite pipes with sufficient dimensional stability can be used.

On the other hand, flexible plastic pipes are used in installations, in particular so-called solid plastic pipes, or pipes made of composite materials, so-called multi-layer composite pipes, consisting of one or more layers of plastic and one or more thin layers of metal. Such pipes are used in particular for the installation of pre-wall technology, such as retrofitted sanitary installations, where the flexible pipes are often bent on site in confined spaces and installed in a curved state. These pipes do not have sufficient dimensional stability and, in order to create the press connection, internal support is required, which is provided by a support sleeve inserted into the open pipe end as part of the fitting.

The properties and suitability of a fitting for pipes and applications are defined by the functional parts connected with or inserted into the fitting, such as sealing elements for sealing the fitting against the inserted pipe and cutting elements that perform the retaining function on the pipe. These functional parts are the components of the fitting that ensure the main functions of sealing and holding.

These functional parts must be adapted to each other for different media or applications. These functional parts are usually pre-assembled at the factory, and subsequent changes to the configuration of the fitting are only possible with increased technical effort and also involve the risk of errors. Therefore, such adjustments are not regularly carried out.

The corresponding visual marking with regard to the suitability of the fitting for the media to be conveyed and other functional properties is also very time-consuming and complex. For this reason, a specific type of fitting must be selected and ordered in advance during the planning stage for each application. There are differences in the types of fittings used for a gas pipe and a water pipe, for example.

The present invention is therefore based on the technical problem of provide a fitting and a system for connecting pipes that at least partially overcome the technical disadvantages described above. In particular, the aim is to enable easier and more reliable interchangeability of the functional parts, thereby reducing complexity and increasing flexibility in application.

### SUMMARY OF THE INVENTION

According to the invention, the technical problem described above is solved by a fitting for connecting to a pipe, with a base body having at least one pipe section, a pressing section connected to the pipe section and a functional unit connected to the pressing section, wherein the functional unit comprises a functional ring, a sealing element and a fixing element, wherein the functional ring has an outer section arranged radially outside the pressing section and an inner section arranged inside the pressing section, and wherein the inner section positions the sealing element and the fixing element inside the pressing section.

The technical problem is also solved by a functional unit for a fitting with a functional ring, a sealing element and a fixing element, wherein the functional ring has an outer section arranged radially outside the pressing section and an inner section arranged inside the pressing section, and wherein the inner section positions the sealing element and the fixing element within the pressing section.

The technical problem is further solved by a system for connecting pipes, with at least one previously described fitting with a functional unit and with at least one further functional unit, wherein at least two functional units differ in the design of at least one of the elements functional ring, sealing element and/or fixing element and/or, if applicable, reinforcement ring.

The designs according to the invention described allow for a variable design of the fitting for different applications such as water pipe arrangements (hot/cold) or gas pipe arrangements.

The functional unit of the fitting described is a separate unit from the base body of the fitting, which separate unit can be pushed onto the open end of the base body, i.e. onto the pressing section, and can also be removed from it again. The functional unit has the essential functional elements for establishing a preferably permanent connection between the fitting and an inserted pipe. The functional unit therefore enables modularity of the fitting, which means increased variability in the possible applications of the fitting.

The base body of the fitting may be the same for different applications, for example for a pipe arrangement for conducting water or for conducting gases, while the functional units differ. This is because, depending on the intended application of the fitting, the number and properties of the functional elements associated with the functional unit may vary.

Thanks to the modularity of the functional unit, it is even possible to decide on construction site which of at least two different functional units are to be connected to the base body in order to prepare the fitting as a whole for a specific application.

This also increases functional reliability, as only the complete functional unit, which is clearly prepared for a specific application, can be replaced on the fitting.

Preferred designs of the base body are explained in the following.

Preferably, the pipe section and the pressing section are integrally formed as parts of the base body. This offers manufacturing advantages, as the base body can be produced from a pipe section and only a few forming steps, such as diameter enlargements, are necessary.

Preferably, the pipe section has a smaller inner diameter than the pressing section, and the transition between the pipe section and the pressing section forms a stop for the functional unit, in particular for the sealing element. The sectional enlargement of the pipe section thus defines a stop which, when the fitting is pressed, leads to a sealing contact of the sealing element between the inserted pipe and the pressing section and/or the transition. The tapering of the pipe section in the proximal direction may also be used as a projection for locking an inwardly directed locking element of the functional unit, which will be described later.

Furthermore, the pipe section may have a first area and a second area, wherein the first area has a smaller inner diameter than the second area and wherein the transition between the first area and the second area forms a stop for the pipe to be inserted. This creates a physical stop for the pipe to be inserted, so that a haptic impression is created when a pipe is installed in the fitting. This allows manual control of the insertion depth.

In a further preferred embodiment, the pressing section has a chamber arranged on the inside and an outwardly protruding part of the fixing element of the functional ring may be arranged in the chamber. The chamber is thus engaged with the radially outwardly protruding part of the fixing element when the functional unit is pushed on, so that a defined position of the entire functional unit is achieved. This constitutes a safety feature during assembly.

If the functional unit is not pushed far enough onto the pressing section and the radially outwardly protruding parts of the fixing element are not completely accommodated in the chamber of the pressing section, then the fixing element protrudes at least partially radially inward. This protrusion may be so large that no pipe with a specified outer diameter can be inserted into the pressing section of the fitting, as the free internal cross-section is not large enough due to the inwardly protruding fixing element.

The previously described designs of the base body with pipe section and pressing section are suitable for the use of an externally sealing fitting, since the functional elements of the sealing element and the fixing element act from the outside on the surface of the pipe to be connected. Therefore, the materials mentioned above as examples can be considered for the pipes to be connected.

Alternatively, however, it may also be provided that a support sleeve for insertion into a pipe to be connected is provided within the pressing section, wherein the support sleeve is connected to the base body in the area of the pipe section or the pressing section. The support sleeve can then be inserted into the pipe to be connected and stabilise the pipe from the inside during and after pressing. This means that flexible pipes made of the above-mentioned materials can be connected with the fitting.

The formation of a support sleeve in the base body does lead to a variation in the design of the base bodies, whereby a distinction is made between an externally sealing and an internally sealing variant. However, the possible applications for pipes to be connected are increased.

The base body of the designs described is preferably made of metal in order to ensure deformability with sufficient hardness and dimensional stability after forming. The metals that can be used are those already mentioned for rigid pipes, for example stainless steels such as ferritic steels like 1.4521, austenitic steels like 1.4404, duplex steels like 1.4462, red brass, SiBr, copper.

However, the base body of the designs described may also consist of a non-metallic material or plastic if the non-metallic material has sufficient properties for pressing and permanently connecting pipes. The following materials, for example, are suitable for this purpose: cross-linked polyethylene (PE-X), silane-cross-linked polyethylene (PE-Xb) or physically cross-linked polyethylene (PE-Xc), polyethylene with increased temperature resistance (PE-RT), polyvinyl chloride (PVC), polypropylene (PP) with appropriate wall thicknesses, polyphenylsulfone (PPSU), polyetheretherketone (PEEK) or polyaryletherketone (PAEK), aliphatic bio-based polyamide (PA410, PA12, PA12-GF30) or polypropylene random copolymer with modified crystal structure and increased temperature resistance (PP-RCT).

In the following, preferred embodiments of the functional unit are explained in more detail.

Firstly, it is preferable that the functional ring is made of plastic. This allows the functional ring to be manufactured inexpensively using common manufacturing processes such as injection moulding. Furthermore, all materials specified above for the base body may also be used. This means that it is also possible to manufacture the ring from metal. Polyethylene (PE) and polypropylene (PP) are preferred because they are inexpensive construction materials. Polyetheretherketone (PEEK) may also be used.

Furthermore, the outer section may have, around its circumference, in particular at the proximal end, at least in sections, an inwardly projecting locking section,. This locking section may engage behind the shoulder at the transition described above between the enlarged pressing section and the tube section, i.e. where the stop for the sealing element is formed on the inside. When the functional unit is pushed far enough onto the open end of the base body onto the pressing section, the locking section engages behind the shoulder, so that the functional unit is positioned at the correct position. In addition, there is a haptic effect when pushing and locking manually, which allows the user to recognise that the functional unit has been installed correctly.

The outer section of the functional ring may form a continuous ring which, when installed, rests against the pressing section with its cylindrical inner surface and to whose outer surface a pressing tool, for example with pressing jaws, can be applied. During pressing, the outer section then transfers the pressing force generated by a pressing jaw to the pressing section of the base body. This causes deformation of the pressing section and thus a tight and stable connection between the fitting and the pipe. The design of the functional ring as a continuous ring is particularly applicable if the functional ring is made of a material that can transfer the force from the pressing tool to the pressing section accordingly. This is the case, for example, if the functional ring is made of a metal, in particular the same metal as the base body. Furthermore, high-strength plastics are also conceivable as a material for the functional ring.

Preferably, the functional ring may have a reinforcement ring described in more detail below. To accommodate such a reinforcement ring, the outer section preferably has a plurality of recesses for accommodating outwardly protruding pressing projections of a reinforcement ring. Further details of this design are given below.

It is further preferred that the inner section of the functional unit has a plurality of recesses for receiving individual cutting elements of the fixing element. The separate cutting elements are arranged in the recesses and thus positioned and are pressed into the material of the pipe by the pressing section during the pressing process, thereby fixing the pipe in the fitting. The separate cutting elements are explained in more detail below.

As an alternative to separate cutting elements, the fixing element may also be designed single-piece as a at least partially ring-shaped fixing element with at least one cutting element. For this purpose, the inner section of the functional unit may have a circumferential recess for receiving the fixing element. The fixing element is typically designed as a ring interrupted at one point, so that the radius of the fixing element can change when it is inserted into the functional unit and pressed.

Furthermore, it may be provided that the inner section of the functional unit is, at least in sections, connected, in particular glued, welded or snapped, to the sealing element at the proximal end. The sealing element itself is preferably made of an elastically deformable material, preferably an elastomeric material, in order to ensure the sealing function. A suitable adhesive, in particular a polyurethane adhesive, may be used for gluing. For welding, for example, a suitable welding process, in particular an ultrasonic welding process, may be used. For snapping, projections and/or retaining elements, which partially enclose the sealing element or otherwise fix it by means of limited penetration, for example by means of needles with barbs, are alternatively provided at the proximal end of the inner section.

The sealing element may be designed as a simple O-ring or have two O-rings connected to each other. A design consisting of two interconnected O-rings has the advantage that, with a short pressing stroke during pressing, i.e. a small radial deformation of the pressing section, a larger volume is filled by the elastomer of the two O-rings. This results in a longer axial sealing distance within the press connection.

The connection only has to be sufficient to position the sealing element in the correct position within the base body in the area of the pressing section in a form-fitting and/or material-locking manner when the functional unit is inserted. The connection between the inner section and the sealing element thus allows the functional unit to be connected to all functional elements and to be connected as a single unit to the pressing section of the base body of the fitting.

As already mentioned, the functional unit may have a reinforcement ring, whereby the outer section of the functional unit positions the reinforcement ring outside the pressing section of the pressing section. The reinforcement ring is thus held by the functional unit and may be placed on the pressing section together with the other functional elements as a single unit.

The reinforcement ring is preferably made of a plastically deformable metal. The same materials that are specified as materials for the base body can be considered. The reinforcement ring is preferably made of the same metal as the base body of the fitting. In particular, the reinforcement ring is used when the functional ring is made of plastic and cannot generate sufficient force during the pressing process.

The combination of base body and reinforcement ring also has the advantage that different materials with complementary or contrasting properties may be combined. For example, materials with high ductility may be used for the reinforcement ring and materials with high strength for the base body.

For example, the base body may be made of simple, inexpensive steel and the reinforcement ring of a special high-strength metal.

Furthermore, for example, the base body may be made of simple, inexpensive steel and the reinforcement ring of a metal that is easy to form.

Furthermore, the base body may be made of high-quality and/or highly resistant material for special fluids (metal or plastic) and the reinforcement ring may be made of inexpensive material to perform the retaining function.

The metal of the functional ring may also be selected specifically for the application.

Furthermore, the reinforcement ring may have a cylindrical inner body and be designed such that the reinforcement ring can rest against the outside of the pressing section. The reinforcement ring may thus transfer a radially inward-directed pressing force evenly to the pressing section through the flat contact surface.

Furthermore, the reinforcement ring may have pressing projections that protrude outwards and are distributed around the circumference. The pressing projections may then be accommodated in circumferentially arranged recesses in the outer section of the functional ring. These recesses have already been described above.

It is further preferred that the pressing projections of the reinforcement ring have an outer diameter that is at least as large as the outer diameter of the outer section of the functional ring. This means that the pressing projections lie directly against the pressing contour of the pressing jaw during the pressing process.

It is also advantageous if the pressing projections occupy more than 50%, in particular more than 60% and preferably more than 70% of the circumference of the reinforcement ring. This design ensures that the pressing force is distributed as evenly as possible over the pressing section of the base body, despite a necessary interruption of the outer circumference between the pressing projections.

The fixing element has already been mentioned and is explained in more detail in the following. Preferably, the fixing element has a plurality of separate cutting elements. The cutting elements protrude radially outward in contact with the inside of the pressing section so that they are pressed radially inward by it during pressing. On the inside, they protrude radially inwards with a cutting edge that comes into contact with the outside of the pipe and, during pressing, penetrates the material of the pipe at least with the cutting edges.

In a preferred embodiment, the fixing element has a plurality of separate cutting elements and the cutting elements are enclosed, i.e. embedded, by the inner section of the functional ring. Furthermore, the cutting elements may have a contact surface on the outer side for contact with the inner side of the pressing section, and the cutting elements may have at least one radially inwardly projecting cutting edge on the inner side. Thus, the radially inward pressing force is transmitted from the pressing section of the base body to the cutting elements, so that the cutting elements partially penetrate the material of the inserted pipe and thus perform the function of the fixing element in the pressed state.

Alternatively, the cutting elements may each have at least one radially protruding cutting edge on the outside and on the inside. This means that the cutting elements also penetrate radially outwards into the material of the pressing section during pressing. In this case, the positioning of the fixing element during pressing takes place both relative to the pipe and relative to the pressing section. It is then not necessary to design the pressing section with an inwardly open chamber to accommodate part of the inner section of the functional ring for positioning the cutting elements.

As an alternative to the design with separate cutting elements, the fixing element may also be designed to be at least section-wise ring-shaped with at least one cutting element, wherein the inner section of the functional ring has a ring-shaped recess for accommodating the fixing element.

A further alternative for the design of the at least partially ring-shaped fixing element is that a plurality of ring elements and a plurality of hinge elements for pivotally connecting two ring elements in each case are provided, wherein the ring elements are designed with cutting elements for holding and/or fixing a pipe to be inserted, wherein the ring elements have a strip shape by means of the hinge elements, and wherein the ring elements can assume a flat shape or a ring shape that is open at the sides. This design has been described in application DE 10 2022 116 679.

If the design of the sealing element and the fixing element allows them to be placed directly against each other, thereby posing a risk of damage to the sealing element by the fixing element, the inner section may also accommodate a separating ring that positions the sealing element and the fixing element at a distance from each other.

The design of the base body with a support sleeve for insertion into the pipe to be connected has already been described above. The support sleeve serves to stabilise the pipe during pressing if the material of the pipe has too high elasticity.

An alternative design for the support sleeve is for the inner section of the functional ring to have, at the proximal end, a support sleeve for insertion into a pipe to be connected. The support sleeve is either formed integrally with the inner section or connected to the inner section as a separate component. The design of the support sleeve together with the functional ring has the advantage that the functional element of the support sleeve is also part of the functional unit and can be pushed onto the pressing section of the base body together with it as a single unit.

The design of a support sleeve with the inner section of the functional ring and the arrangement of a support sleeve as part of the base body may also be combined with each other. In this case, the support sleeve formed with the inner section may have a sealing element and, where appropriate, at least part of the fixing element, while the support sleeve formed with the base body alone ensures mechanical stability. Thus, the basic idea of the functional unit remains completely intact in an advantageous manner, even with pipes that need to be sealed on the inside.

The technical problem outlined above is also solved by a system for connecting pipes with at least one base body of a previously described fitting and with at least two previously described functional units, wherein at least two functional units differ in the design of at least one of the elements functional ring, reinforcement ring, cutting elements and/or sealing element.

The idea behind the system is that fittings for different applications are based on the same basic body of the fitting and can be equipped with differently configured functional units. In a basic configuration, a base body, a first functional unit and a second functional unit with a configuration that differs from the first functional unit are provided for this purpose. In a practical application of the system, a plurality of base bodies and a plurality of functional units are provided for a construction site in groups of configurations for at least two different applications, such as water pipes and gas pipes.

It is preferable that the shape, material and/or surface design of at least two functional rings, at least two reinforcement rings, two sealing elements and/or at least two fixing elements differ.

It is preferable that the functional ring of the functional units has a colour code for a specific application, which in turn requires different materials for the sealing element. For example, different colours of the functional rings with specific sealing materials may be assigned to specific areas of application: for example
yellow for the application with gas pipes with a sealing element approved for gas pipes,
green for drinking water pipes with a sealing element approved for drinking water pipes,
red (flow) and blue (return flow) for heating water pipes with a sealing element approved for heating water pipes, and
orange for hazardous goods pipes with a sealing element approved for the specific hazardous goods.

The aforementioned designs of the functional ring as part of the functional unit represent an independent invention that is claimed independently of the other designs of the functional unit.

### BRIEF DESCRIPTION OF THE DRAWINGS

In the following, the invention is explained below using exemplary embodiments with reference to the drawing. In the drawing

FIG. 1 shows a first exemplary embodiment of a fitting with a functional unit,

FIG. 2 shows the fitting from FIG. 1 with the functional unit detached,

FIG. 3 shows the fitting from FIG. 1 in an exploded view of the components,

FIG. 4 shows the functional unit of the fitting from FIG. 1,

FIGS. 5 and 6 show the fixing element of the fitting with separate cutting elements according to FIG. 1,

FIG. 7 shows the fitting from FIG. 1 with inserted pipe in cross-section before pressing,

FIG. 8 shows the fitting from FIG. 1 with inserted pipe in cross-section after pressing,

FIG. 9 shows a second exemplary embodiment of a fitting with functional unit,

FIG. 10 shows the fitting from FIG. 9 with functional unit detached,

FIG. 11 shows the fitting from FIG. 9 in an exploded view of the components,

FIG. 12 shows the functional unit of the fitting from FIG. 9,

FIG. 13 shows the reinforcement ring of the fitting according to FIG. 9,

FIG. 14 shows the fitting from FIG. 9 with inserted pipe in cross-section before pressing,

FIG. 15 shows the fitting from FIG. 9 with inserted pipe in cross-section after pressing,

FIG. 16 shows a third exemplary embodiment of a fitting with inserted pipe in cross-section before pressing,

FIG. 17 shows the fitting according to FIG. 16 after pressing,

FIG. 18 shows a fourth exemplary embodiment of a fitting with inserted pipe in cross-section before pressing,

FIG. 19 shows the fitting according to FIG. 18 after pressing,

FIG. 20 shows a fifth exemplary embodiment of a fitting with fully pushed-on functional ring,

FIG. 21 shows the fitting from FIG. 20 with the functional ring only partially pushed on,

FIG. 22 shows a sixth exemplary embodiment of a fitting with double-sided cutting elements,

FIG. 23 shows a schematic representation of a system consisting of a base body and functional units.

### DESCRIPTION OF THE INVENTION

In the following description of the various exemplary embodiments of the invention, components and elements with the same function and mode of operation are assigned the same reference numerals, even if the components and elements may differ in their dimensions or shape in the various embodiments.

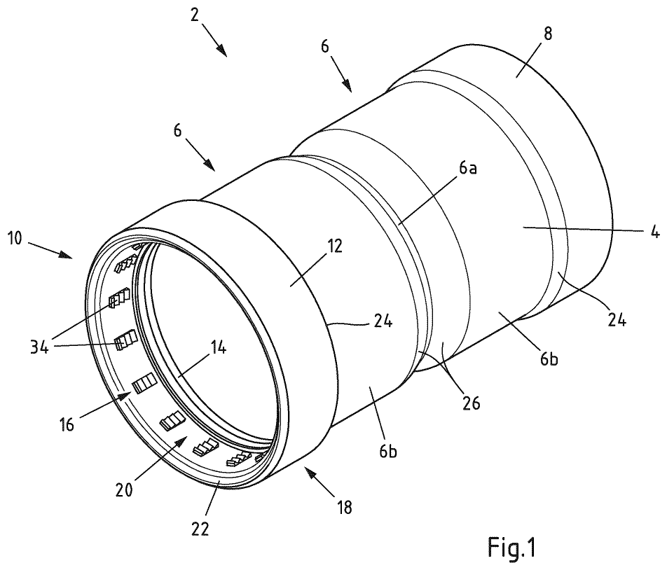

FIGS. 1 to 8 show a first exemplary embodiment of a fitting 2 for connecting to a pipe according to the invention.

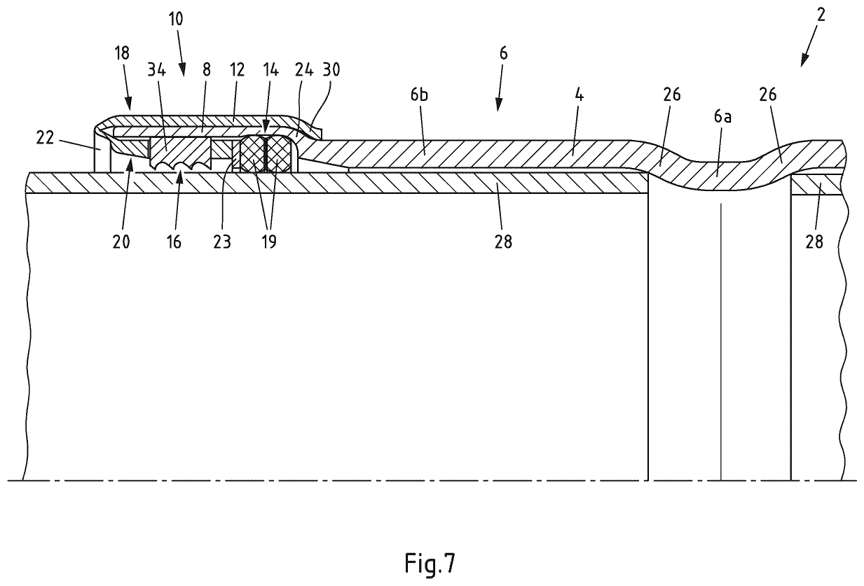

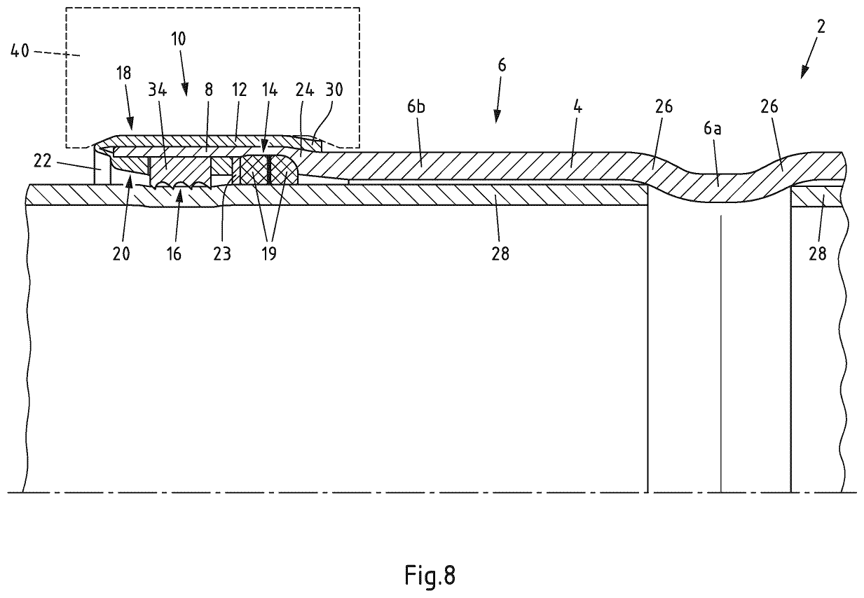

According to FIGS. 1 to 3, the fitting 2 has a base body 4 with at least one pipe section 6 and a pressing section 8 connected to the pipe section 6. In the present case, the pipe section 6 and pressing section 8 are integrally formed and can be produced by forming a piece of pipe, as can be seen in the cross-section in FIGS. 7 and 8. FIG. 1 shows the free end of the pressing section 8 on the right-hand side of the fitting 2.

Furthermore, a functional unit 10 connected to the pressing section 8 is provided, which functional unit can be manually pushed onto the pressing section 8 and removed again. Therefore, the functional unit 10 may also be installed on the construction site, or a pre-installed functional unit 10 may be removed and replaced with another functional unit 10. FIG. 1 shows, on the left side of the fitting 2, the pushed-on functional unit 10 surrounding the pressing section 8.

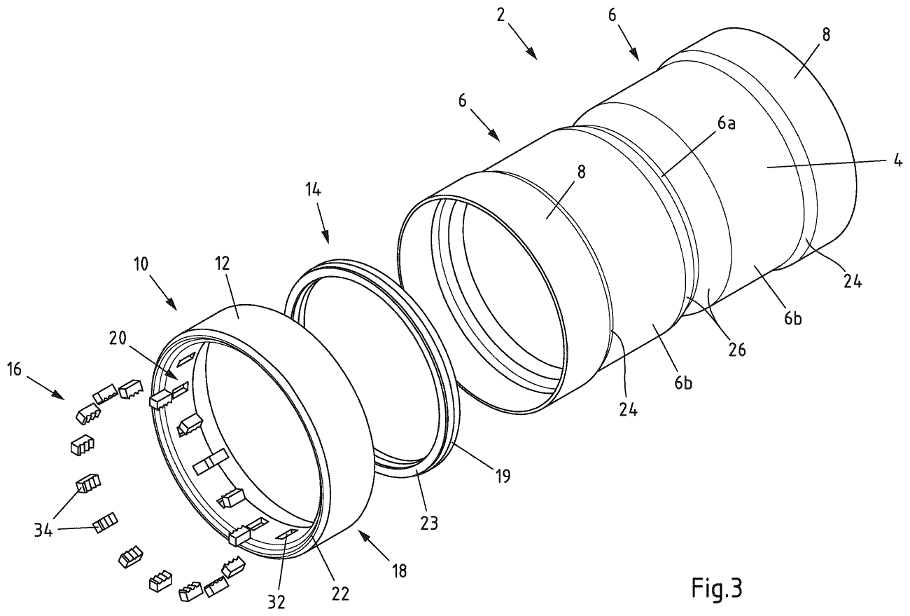

FIG. 3 shows the fitting 2 in an exploded view. The functional unit 10 has a functional ring 12, a sealing element 14 and a fixing element 16, so that the functional elements 14 and 16 required for the functionality of the fitting are connected to the functional ring 12 and can be handled as a functional unit 10.

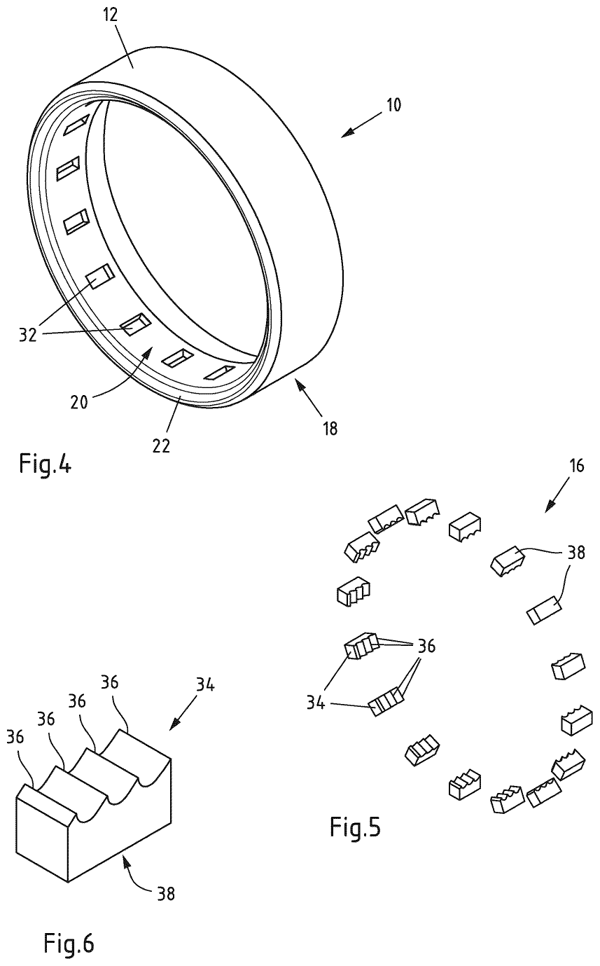

The functional ring 10 according to FIG. 4, as also shown in cross-section in FIGS. 7 and 8, has an outer section 18 arranged radially outside the pressing section 8 and an inner section 20 arranged inside the pressing section 8, which are connected to each other by means of an annular web 22. The radial distance between the essentially cylindrical outer section 18 and the essentially cylindrical inner section 20 corresponds approximately to the wall thickness of the pressing section 8. Thus, the functional ring 10 can be arranged on the pressing section 8, surrounding the distal end of the pressing section 8 from the outside and inside. Preferably, the outer section 18 rests against the outside of the pressing section 8 and the inner section 20 rests against the inside of the pressing section 8.

The inner section 20 positions the sealing element 14 and the fixing element 16 within the pressing section 8. Thus, when the functional ring 10 has been completely pushed onto the open end of the pressing section, the two functional elements 14 and 16 are also arranged in the correct position.

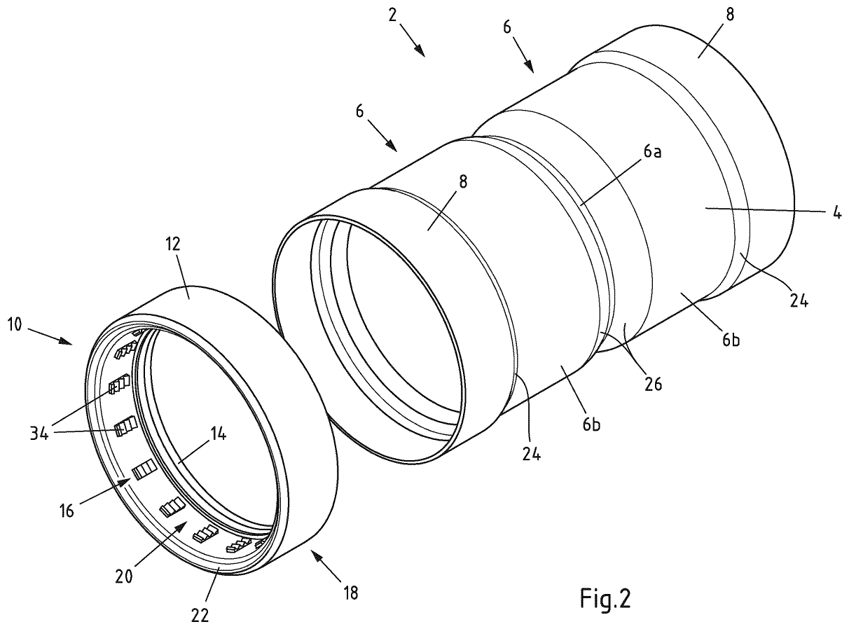

FIGS. 1 and 2 as well as FIGS. 7 and 8 show that the sealing element 14 is designed as a double ring-shaped elastomeric seal 19, which is connected to the proximal end of the inner section 20. A glued connection is used to attach the elastomeric seals 19 to the inner section 20. To stabilise the glued connection, an additional ring 23 is provided, which allows the elastomeric seals 19 to be pre-installed in order to make it easier to bond the sealing element 14 thus formed to the inner section 20. The ring 23 also serves as a separating ring between the sealing element 14 and the fixing element 16.

The design of the sealing element 14 as two O-rings 19 allows sufficient elastomer material to be placed in the sealing area to create a larger sealing surface.

Alternatively, a single O-ring 19 may also be used. This can be connected to the inner section 20 as described. However, the O-ring 19 may also be inserted into an annular recess on the inner section 20.

The pipe section 6 of the base body 4 has a smaller inner diameter than the pressing section 8, and the transition between the pipe section 6 and the pressing section 8 forms a stop 24 for the functional unit 10. The stop 24 serves in particular for the sealing element 14, which thus rests between the pressing section 8 or the stop 24 and the pipe 28 to be inserted, as shown in FIGS. 7 and 8.

Furthermore, the pipe section 6 has a first area 6a and a second area 6b, wherein the first area 6a has a smaller inner diameter than the second area 6b and wherein the transition between the first area 6a and the second area 6b forms a stop 26 for the pipe 28 to be inserted, as shown in FIGS. 7 and 8.

The outer section 18, around its circumference, at the proximal end, has an inwardly projecting locking section 30, as shown in particular in FIG. 7. When pushed on, the outer section 18 is slightly expanded and then snaps into place on the outside of the transition or stop 24 between the tube section 6b and the enlarged pressing section 8. In this way, a predefined position of the functional unit 10 as a whole is achieved.

The inner section 20 also has a plurality of recesses 32 for receiving individual cutting elements 34 of the fixing element 16. The separate cutting elements 34 have the advantage that they are each surrounded by the material of the inner section 20 and can therefore be positioned very accurately.

FIG. 7 shows in the cross-section shown that the cutting elements 34 protrude radially inwards with a cutting edge 36 and on the outside, with a contact surface 38, are in contact with the inside of the pressing section 8.

FIGS. 7 and 8 show the state before and after pressing the fitting 2 by means of a pressing tool with a pressing jaw 40. During pressing, the pressing jaw 40 is mechanically driven to perform a radially inward movement. This causes the pressing to take place and a reduction in the diameter of the pressing section 8 is achieved to permanently connect the fitting 2 to the pipe 28.

FIG. 8 shows the pressed state in which the reduction in diameter of the pressed section 8 has resulted in the sealing element 14, consisting of the two sealing rings 19, being pressed between the pressed section 8 or the shoulder 24 of the base body 4 and the pipe 28. The base body 4 is thus sealed against the pipe 28. On the other hand, the cutting elements 34 are supported against the inside of the pressing section 8 and have partially penetrated the material of the pipe 28. This fixes the position of the pipe 28 within the base body 4 and creates a permanent connection between the fitting 2 and the pipe 28.

The functional ring 10, which has to transfer the pressing force of the pressing jaw 40 to the pressing section 8 with its outer section 18 during the pressing process, is preferably made of a deformable metal or a rigid plastic in the exemplary embodiment shown. Since the pressing section 8 remains permanently deformed after pressing, permanent deformation of the outer section 18 is not necessary. Therefore, materials that do not remain permanently deformed may also be considered.

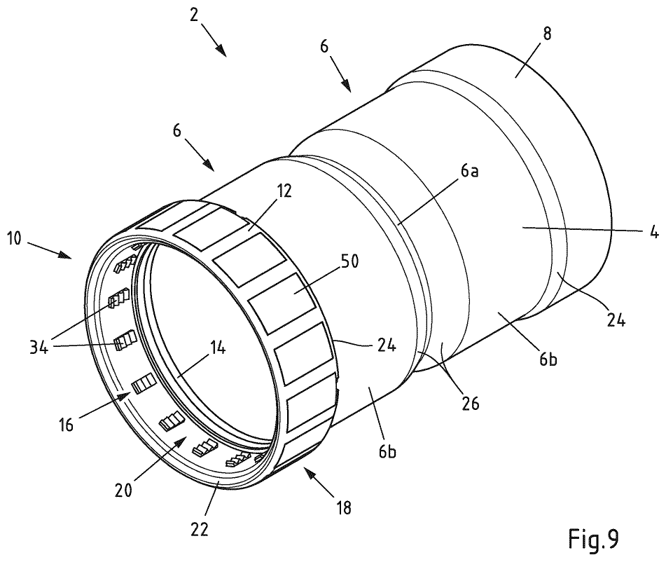

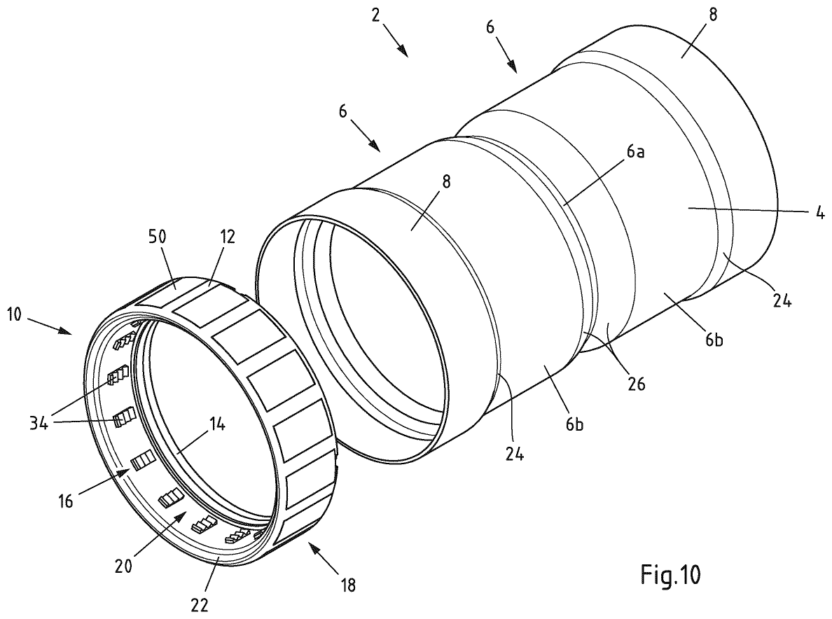

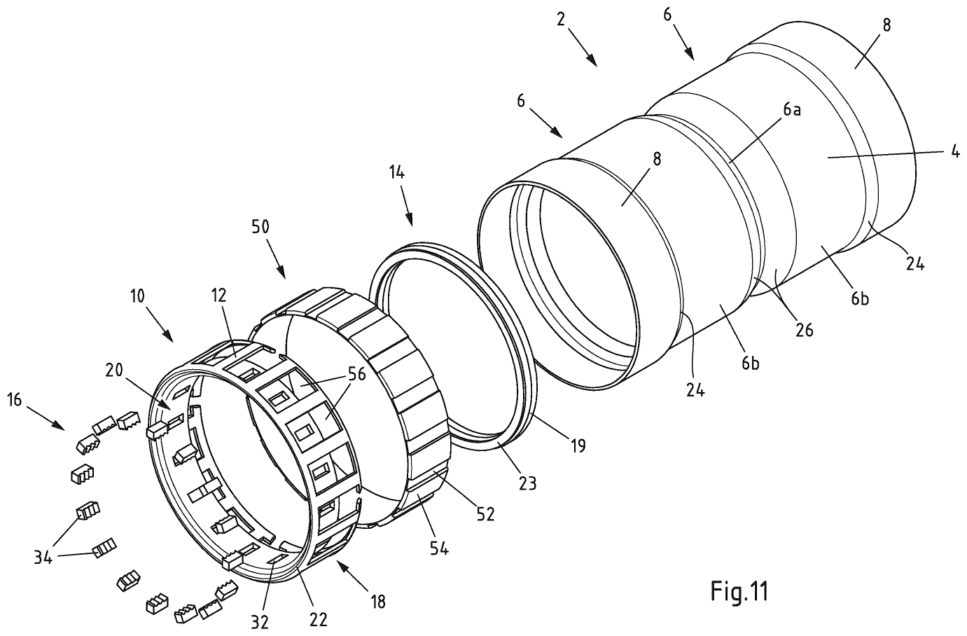

FIGS. 9 to 15 show a second exemplary embodiment of a fitting 2 according to the invention, in which in particular the outer section 18 of the functional ring 12 has been modified. Therefore, the description of the other components of the fitting 2 as previously given for the first exemplary embodiment according to FIGS. 1 to 8 applies.

In the second exemplary embodiment, a reinforcement ring 50 is provided in addition to the outer section 18, and the outer section 18 positions the reinforcement ring 50 outside the pressing section 8. The function of the reinforcement ring 50 is to transfer the pressing force exerted by the pressing jaw 40 more evenly and reliably to the pressing section 8 during pressing. The reinforcement ring 50 is made of a plastically deformable metal, so that the pressing force is transferred predominantly or exclusively via metal components.

The material of the reinforcement ring 50 is preferably identical to the material of the base body 4.

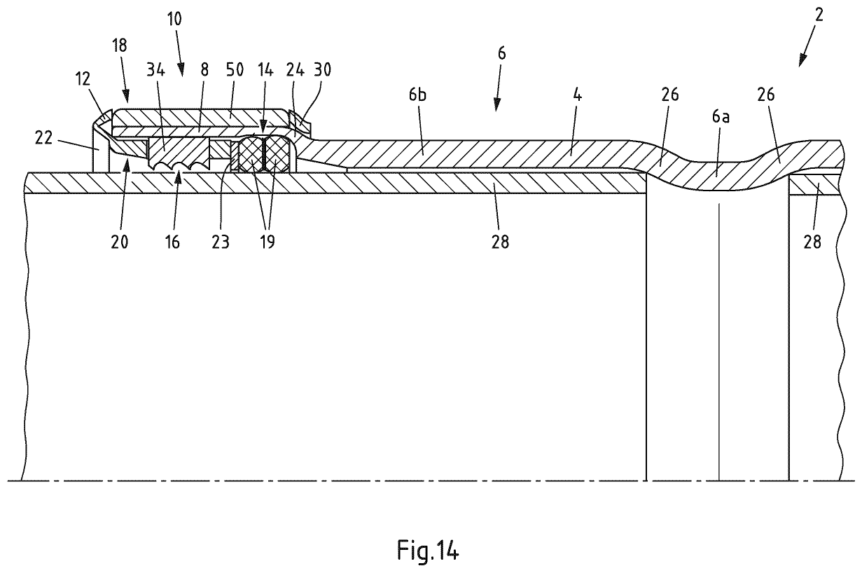

As shown in FIG. 13, the reinforcement ring 50 has a cylindrical inner body 52 which rests against the outside of the pressing section 8, as shown in FIG. 14. Furthermore, the reinforcement ring 50 has pressing projections 54 that protrude outwards and are distributed around the circumference. The pressing projections occupy approximately 65% of the circumference, while the outer contour is determined by the inner body 52 along the remaining circumference.

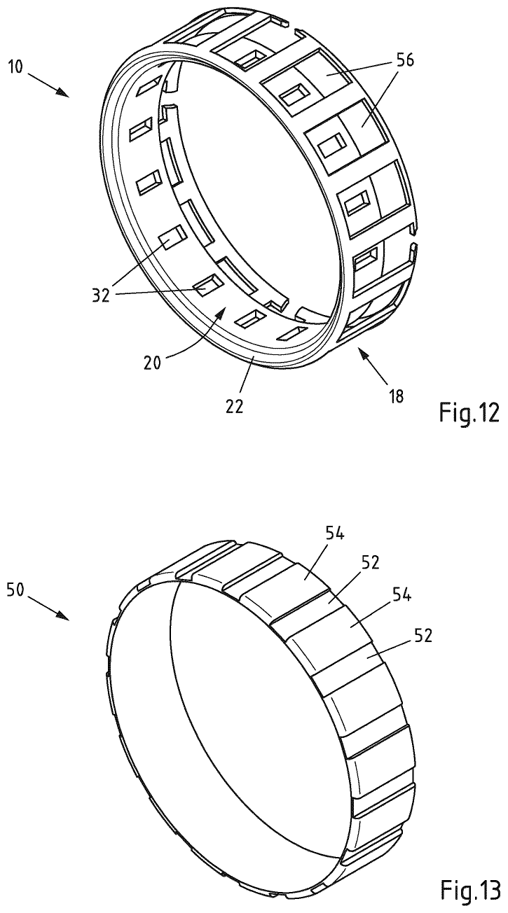

To accommodate the reinforcement ring 50, the outer section 18 of the functional ring 12 has a plurality of recesses 56 for receiving the outwardly protruding pressing projections 54 of the reinforcement ring 50, as shown in FIG. 12. The arrangement of the recesses 56 can be seen in particular in FIG. 12.

To ensure reliable functioning of the reinforcement ring 50 during pressing, the pressing projections 54 of the reinforcement ring 50 have a slightly larger outer diameter than the outer diameter of the outer section 18 of the functional ring 12. The pressing projections 54 thus reliably contact the inside of the pressing section 8 due to their dimensions.

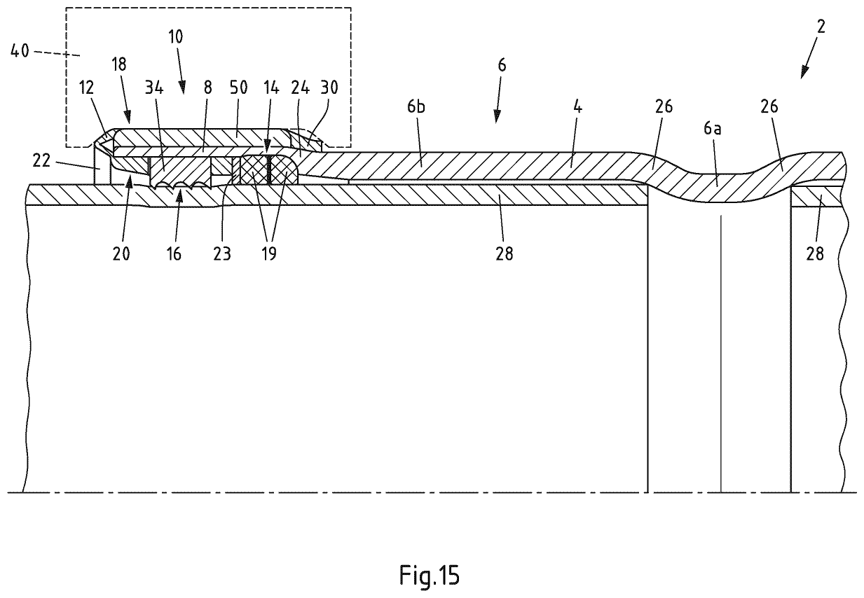

FIGS. 14 and 15 show the previously described fitting 2 with inserted pipe 28 before and after pressing by the pressing jaw 40.

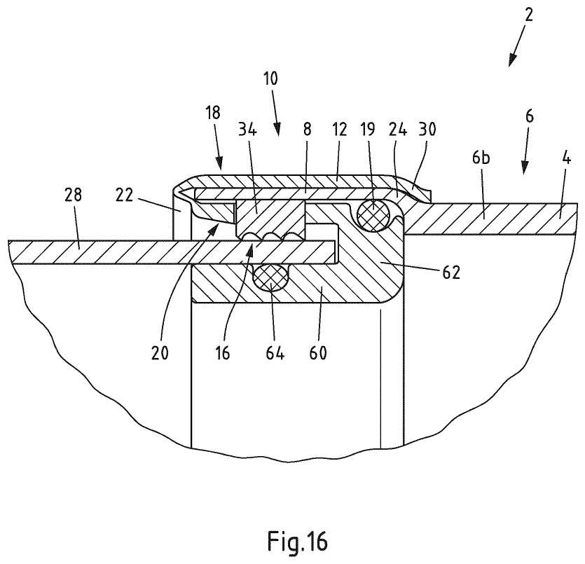

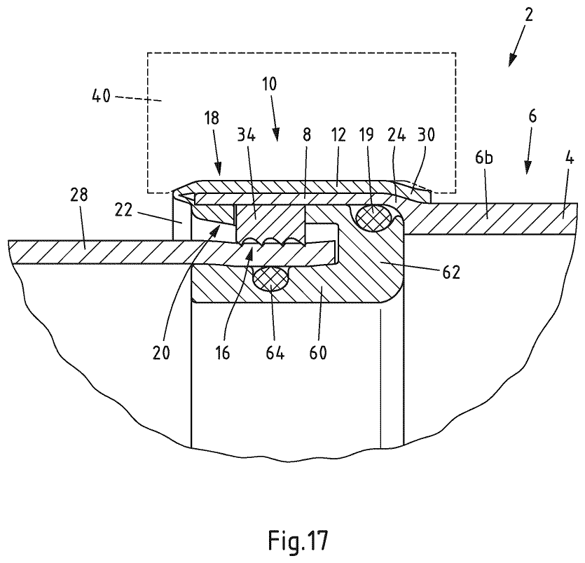

FIGS. 16 and 17 show an exemplary embodiment in which a pipe 28 is to be pressed, the material properties of which do not remain dimensionally stable during and after a pressing process, i.e. which is flexible. For this purpose, a support sleeve 60 is provided, which is formed as part of the functional ring 12. For this purpose, the functional ring 12 has a radially inwardly extending web 62 at the proximal end of the inner section 20, followed by the support sleeve 60 in the distal direction. According to FIG. 16, the outer surface of the support sleeve 60 rests against the inside of the inserted and not yet pressed pipe 28 and supports the pipe 28 from the inside during and after pressing. This ensures that the pipe 28 retains its shape and that the connection is permanently secure and tight.

To seal this connection, a seal 64 is provided on the outer surface of the support sleeve 60, which, in the pressed state according to FIG. 17, seals the pipe 28 against the functional ring 12.

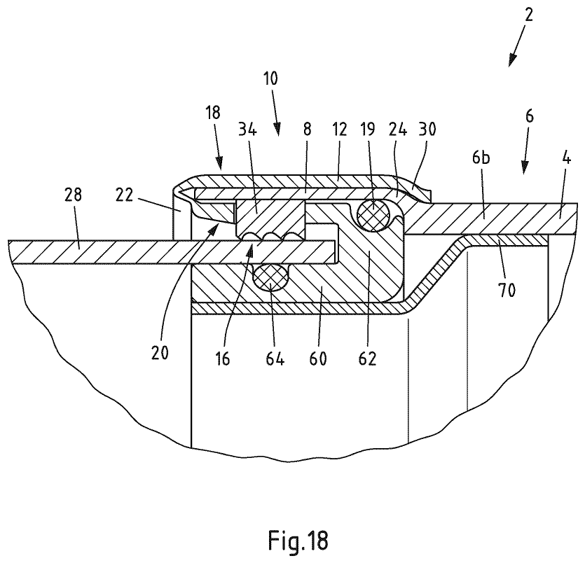

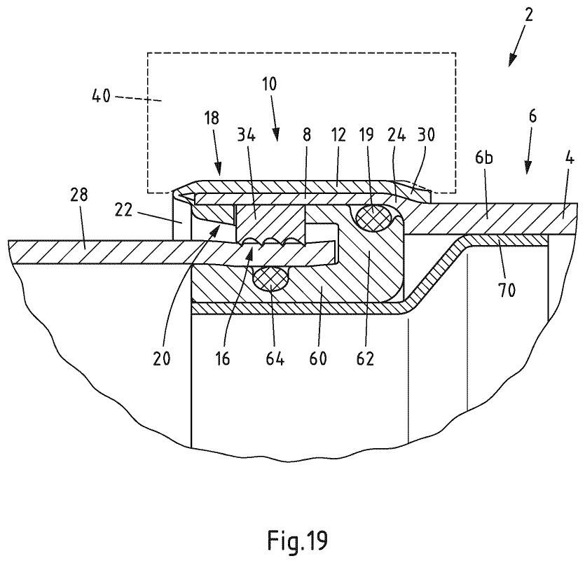

FIGS. 18 and 19 show a further design of the previous exemplary embodiment, which is relevant if the material of the functional ring 12 itself is not sufficiently dimensionally stable to reliably ensure the support function. In the exemplary embodiment shown, an additional support sleeve 70 made of the material of the base body 4 is connected to the base body 4 and extends within the pressing section 8. In particular, the support body 70 is connected to the base body 4 by a welded joint. The outer side of the support body 70 rests against the inner side of the support body 60 and supports the support body 60 during and after pressing.

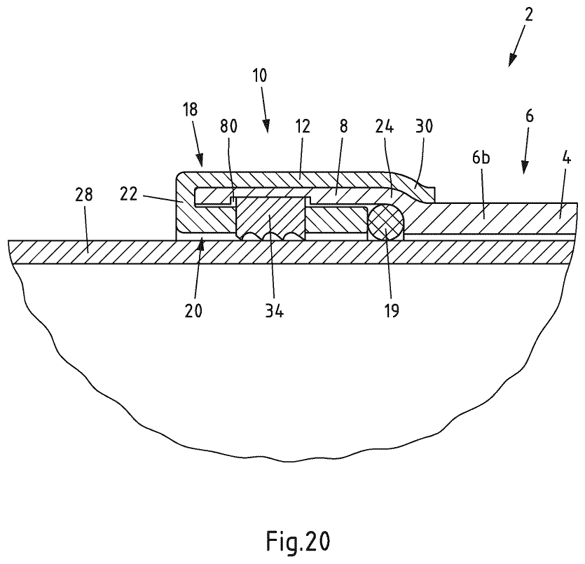

FIG. 20 shows a fitting 2 with a pressing section 8, which has a chamber 80 arranged on the inside. Radially outwardly protruding parts of the cutting elements 34 of the fixing element 16 are arranged in the chamber 80 when the functional ring 12 is fully pushed on. Thus, when the functional unit 10 is pushed onto the pressing section 8, part of the fixing element 16 engages in the pressing section 8 and the functional ring 10 is positioned exactly. This locking function works together with the locking function provided by the outer locking section 30. This provides a safety feature for the user when manually sliding on the functional unit 10.

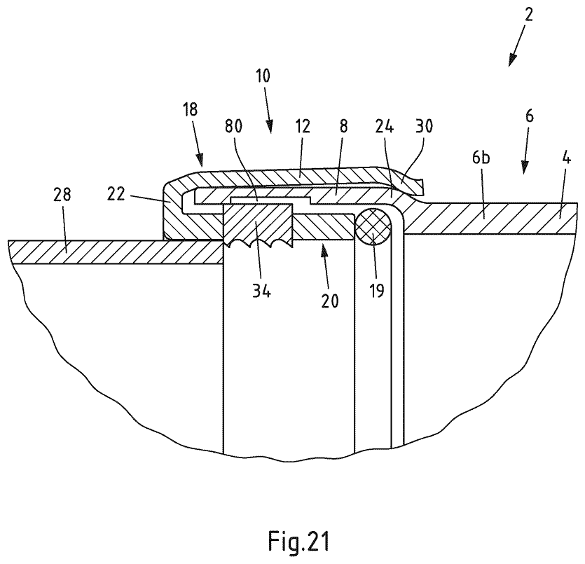

FIG. 20 also shows that when the functional unit 10 is fully pushed on, the tube 28 can be fully inserted so that it can then be pressed. FIG. 21, on the other hand, shows the state when the functional unit 10 is not fully pushed onto the pressing section 8. In this state, the cutting elements 34 do not engage completely in the chamber 80 and protrude further radially inwards than is the case in the fully pushed-on state in FIG. 20. This reduces the free internal cross-section of the functional unit 10, so that a pipe 28 to be pressed cannot be inserted into the pressing section 8. This additional safety feature prevents installation errors, especially when the functional units 10 are replaced or installed on construction site.

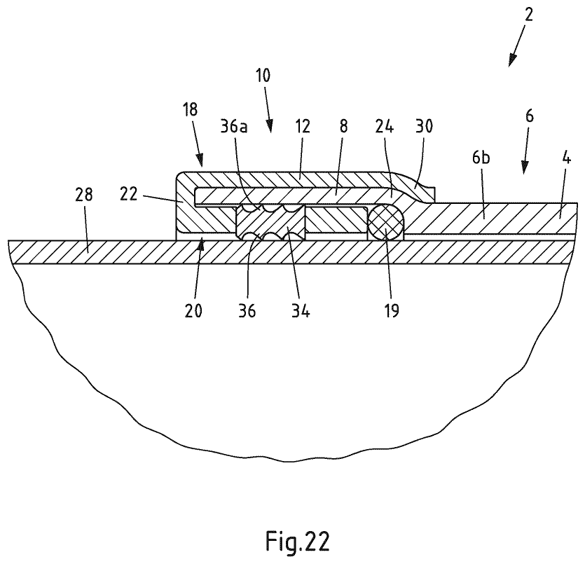

FIG. 22 shows a further embodiment of a fitting 2, in which the cutting elements 34 on the outside and on the inside each have at least one radially protruding cutting edge 36 and 36a. This allows the cutting element 34 shown to press into both the material of the pipe 28 and the material of the pressing section 8 during pressing, thereby improving the fixation of the pipe 28 in the fitting 2.

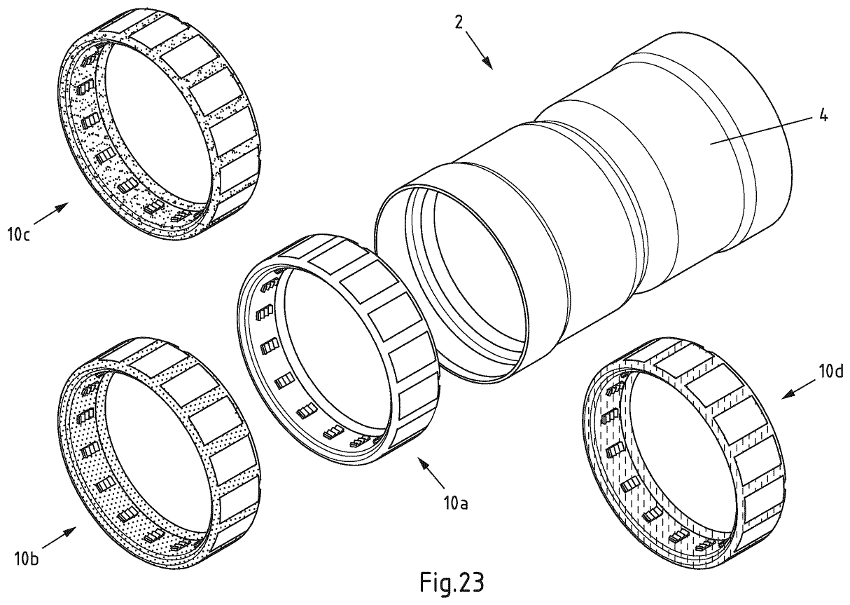

FIG. 23 shows a system for connecting pipes 28, which comprises at least one base body 4 for a fitting 2 according to one of the preceding exemplary embodiments and four different functional units 10a to 10d, each according to one of the preceding exemplary embodiments. The functional units 10a to 10d shown side by side are each designed for a specific application and differ in the design of at least one of the elements functional ring 12, sealing element 14 and/or fixing element 16 and/or, if applicable, reinforcement ring 50. The shape, material and/or surface design of at least two functional rings 12, two sealing elements 14 and/or at least two fixing elements 16 and/or at least two reinforcement rings 50 may differ.

For example, different materials are required for the sealing element 14 for different media conveyed in the pipes to be connected. In this respect, a functional unit 10a may have a sealing element for water pipes and the plastic material of the functional ring is coloured green. Another functional unit 10b may have a sealing element for gas pipes, and the plastic material of the functional ring is coloured yellow. Since parts of the functional ring are always visible from the outside, the colour of the functional ring 10a or 10b can be used to identify the application for which the respective functional unit is intended.

1-18. (canceled)

19. A fitting or connecting to a pipe,
with a base body having at least one pipe section,
with a pressing section connected to the pipe section and
with a functional unit connected to the pressing section,
wherein the functional unit comprises a functional ring, a sealing element and a fixing element,
wherein the functional ring has an outer section arranged radially outside the pressing section and an inner section arranged inside the pressing section, and
wherein the inner section positions the sealing element and the fixing element within the pressing section,
wherein
the inner section of the functional unit has a plurality of recesses for receiving individual cutting elements of the fixing element or
the fixing element is at least section-wise ring-shaped with at least one cutting element and the inner section has a ring-shaped recess for accommodating the fixing element.

20. The fitting according to claim 19,
wherein
the pressing section has a chamber arranged on the inside and
a radially outwardly protruding part of the fixing element of the functional ring is arranged in the chamber.

21. The fitting according to claim 19, wherein a functional unit described below is used as the functional unit.

22. A functional unit for a fitting, which has a base body having at least one pipe section and with a pressing section connected to the pipe section, in particular a fitting according to claim 19,
with a functional ring,
with a sealing element and
with a fixing element,
wherein the functional ring, when the functional unit is connected to the pressing section, has an outer section arranged radially outside the pressing section and an inner section arranged inside the pressing section, and
wherein the inner section positions the sealing element and the fixing element within the pressing section,
wherein
the inner section of the functional unit has a plurality of recesses for receiving individual cutting elements of the fixing element or
the fixing element is at least section-wise ring-shaped with at least one cutting element and the inner section has a ring-shaped recess for accommodating the fixing element.

23. The functional unit according to claim 22,
wherein the outer section, around its circumference, in particular at the proximal end, has, at least in sections, an inwardly projecting locking section.

24. The functional unit according to claim 22,
wherein the outer section has a plurality of recesses for receiving outwardly protruding pressing projections of a reinforcement ring.

25. The functional unit according to claim 22,
wherein the inner section is connected to the sealing element at the proximal end, at least in sections, by a form-fit and/or material-fit connection, in particular by gluing, welding or snapping.

26. The functional unit according to claim 22,
wherein
a reinforcement ring is provided and
the outer section positions the reinforcement ring outside the pressing section.

27. The functional unit according to claim 26,
wherein the reinforcement ring has a cylindrical inner body and is designed to rest against the outside of the pressing section.

28. The functional unit according to claim 26,
wherein the reinforcement ring has pressing projections that protrude outwards and are distributed around the circumference.

29. The functional unit according to claim 26,
wherein the pressing projections are received in circumferentially arranged recesses of the outer section of the functional ring.

30. The functional unit according to claim 26,
wherein the pressing projections of the reinforcement ring have an outer diameter that is at least as large as the outer diameter of the outer section of the functional ring.

31. The functional unit according to claim 22,
wherein
the fixing element has a plurality of separate cutting elements and
the cutting elements are enclosed by the inner section.

32. The functional unit according to claim 31,
wherein
the cutting elements have a contact surface on the outside for contact with the inside of the pressing section and
the cutting elements have at least one radially inwardly protruding cutting edge on the inside.

33. The functional unit according to claim 31,
wherein the cutting elements have at least one radially protruding cutting edge on both the outer side and the inner side.

34. A system for connecting pipes,
with at least one base body for a fitting for connecting to a pipe, wherein the base body has at least one pipe section and a pressing section connected to the pipe section and
with at least two functional units,
wherein the functional units each comprise a functional ring, a sealing element and a fixing element and wherein the respective functional ring, when the functional unit is connected to the pressing section, has an outer section arranged radially outside the pressing section and an inner section arranged inside the pressing section, wherein the inner section positions the sealing element and the fixing element within the pressing section,
wherein at least two functional units differ in the design of at least one of the elements functional ring, sealing element and/or fixing element and/or, if applicable, reinforcement ring.

35. The system according to claim 34,
wherein the shape, material and/or surface design of at least two functional rings, two sealing elements and/or at least two fixing elements and/or at least two reinforcement rings differ.
